(19) United States
(12) Patent Application Publication
(10) Pub. No.: US 2026/0154287 A1
(43) Pub. Date: Jun. 4, 2026

(54) MULTI-REGION DISTRIBUTED DATABASE

(71) Applicant: Amazon Technologies, Inc., Seattle, WA (US)

(72) Inventors: Marc Brooker, Seattle, WA (US); Marc Bowes, Seattle, WA (US); Steven Michael Hershey, Seattle, WA (US); Junaid Azad Mohammed, Kirkland, WA (US); Izak Van Der Merwe, Seattle, WA (US)

(73) Assignee: Amazon Technologies, Inc., Seattle, WA (US)

(21) Appl. No.: 18/964,230

(22) Filed: Nov. 29, 2024

(51) Int. Cl. G06F 16/27

(52) U.S. Cl. CPC G06F 16/27

(57) ABSTRACT

A database system provides query processors on demand for accepting customer connections to a database and stores database data in a separate storage layer, via storage nodes each storing a shard or shard replica of the database data. The database system provides a multi-region configuration wherein customers can access a multi-region database from any of multiple regions of a service provider network. In response to a region-wide failure event, query processors are provided on demand in a failover region. Additionally, to ensure sufficient storage node capacity is maintained in a potential failover region, a multi-region control plane distributes load or configuration information to local control planes of each of the regions of the multi-region database to ensure sufficient storage layer scaling is performed to support a failure over event resulting from a region-wide failure.

### BACKGROUND

Service providers, such as cloud-based service providers, operate networks that often span multiple regions, such as regions of a country, or regions of the world. Also, within a given region multiple availability zones may be implemented, wherein data centers of a given region are located in different availability zones of the given region that have minimal shared dependencies. The use of independent availability zones avoids correlated failures. Additionally, service provider networks may implement transit centers to facilitate communications between regions, wherein a set of data centers in different availability zones of a given region are connected to data centers in different availability zones of another region via a transit center.

However, due to the distances between regions, databases are often implemented within a single region. For example, a control plane for a distributed database may operate within a region, but not coordinate across regions. Thus, in the event of a region-wide failure event, database services may be interrupted.

### BRIEF DESCRIPTION OF THE DRAWINGS

FIGS. 1A-1E are block diagrams illustrating a multi-region distributed database service which includes local control planes in each region and a multi-region control plane, wherein the multi-region control plane coordinates scaling across regions in order to have sufficient capacity to absorb the load of a given region, in remaining regions, in case of a region-wide failure event in the given region, according to some embodiments.

FIG. 2 is a block diagram illustrating availability zones of the respective regions, according to some embodiments.

FIG. 3A is a block diagram illustrating a storage layer configuration for each region of a multi-region distributed database, wherein the multi-region distributed database includes more than two regions, according to some embodiments.

FIG. 3B is a block diagram illustrating a region-wide failure event occurring in a highest load region of a multi-region distributed database, wherein the load of the highest load region is shifted to remaining ones of the regions, according to some embodiments.

FIG. 3C is a block diagram illustrating a region-wide failure event occurring in an intermediate load region of a multi-region distributed database, wherein the load of the intermediate load region is shifted to another one of the regions, according to some embodiments.

FIG. 3D is a block diagram illustrating a region-wide failure vent occurring in a lowest load region of a multi-region distributed database, wherein the load of the lowest load region is shifted to remaining ones of the regions, according to some embodiments.

FIG. 4 is a block diagram illustrating a multi-region control plane a multi-region distributed database collecting health and loading information from components of the respective regions of the multi-region distributed database, according to some embodiments.

FIG. 5 is a flowchart for a process of monitoring and scaling storage layer capacity in each region of a multi-region distributed database in order to provide failover resilience, according to some embodiments.

FIG. 6 is a flowchart for a process of performing a failover operation between regions of a multi-region distributed database, according to some embodiments.

FIG. 7 is a block diagram illustrating various components of a database region and storage service that form a regional portion of a multi-region distributed database, according to some embodiments.

FIG. 8 is a block diagram illustrating a provider network that may implement database services that implement techniques described herein, according to some embodiments.

FIG. 9 is a block diagram illustrating an example computer system that implements some, or all, of the techniques described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION

A database system may include storage layers implemented in a plurality of regions of a service provider network. Also, in some embodiments, query processors may be instantiated for processing customer queries and may be short-lived. For example, a query processor may be provided in response to a customer query to connect to the database system and may be released when the connection terminates, or when customer activity stops. The processing resources of the query processor may subsequently be released and become available to implement another query processor for use in executing other queries for other customers. However, the data stored in the database system is longer-lived and cannot easily be moved on the fly in response to customer connections. Accordingly, a storage layer of the database system stores the customer data in shards hosted by storage nodes, each storing one or more shards of the distributed database data. Additionally, a commit layer of the distributed database accepts and commits incoming writes. The writes are written to a journal and later moved to the storage layer. For example, management instances of the storage layer read data committed to the journal and write the committed data to appropriate shards hosted by storage nodes of the storage layer based on a storage layer shard mapping. (Note that a different shard mapping may be used for the commit layer that is different from the key-to-shard mapping used by the storage layer). In some embodiments, reads are performed in response to a query processor issuing a request to read data to a storage node, wherein the read path is outside of the commit path, e.g. the query processor can issue read requests directly to shards stored in the storage layer without having to interact with the commit layer when performing reads. Writes are performed in response to a query processor issuing a write request to a commit layer adjudicator instance, wherein the commit layer adjudicator instance writes the write data to a journal and in response to successfully writing the write data, provides a write acknowledgement indicating that the write data has been committed in the distributed database.

Since query processors can be quickly provided to customers from a warm pool of instantiated query processor virtualized computing instances or containers, in the event of a region-wide failure, a customer can be connected to query processors in an alternative region of the service provider network and be allocated query processors from a warm pool of the alternative region. However, for storage, there already needs to be copies of customer data stored in a sufficient number of shards hosted by storage nodes of the alternative region in order for the query processors to be able to read customer data in the alternative region. For example, replicating data across regions in response to a region-wide failure event may increase response latency and may cause customer interruption. Thus, it is desirable to have already stored shards (and shard replicas) in the alternative region prior to the region-wide failure event. This allows the query processors, which can be quickly provisioned in the alternative region, to immediately start processing queries, which involve reads of customer data.

In some embodiments, in order to provide a high-level of service to customers, a multi-region control plane of a multi-region distributed database coordinates storage layer capacity across regions to ensure a sufficient number of storage shards (or shard replicas) are implemented in each of the regions of the multi-region distributed database such that a region-wide failure event in a given region of the multi-region distributed database can be absorbed by remaining regions of the multi-region distributed database.

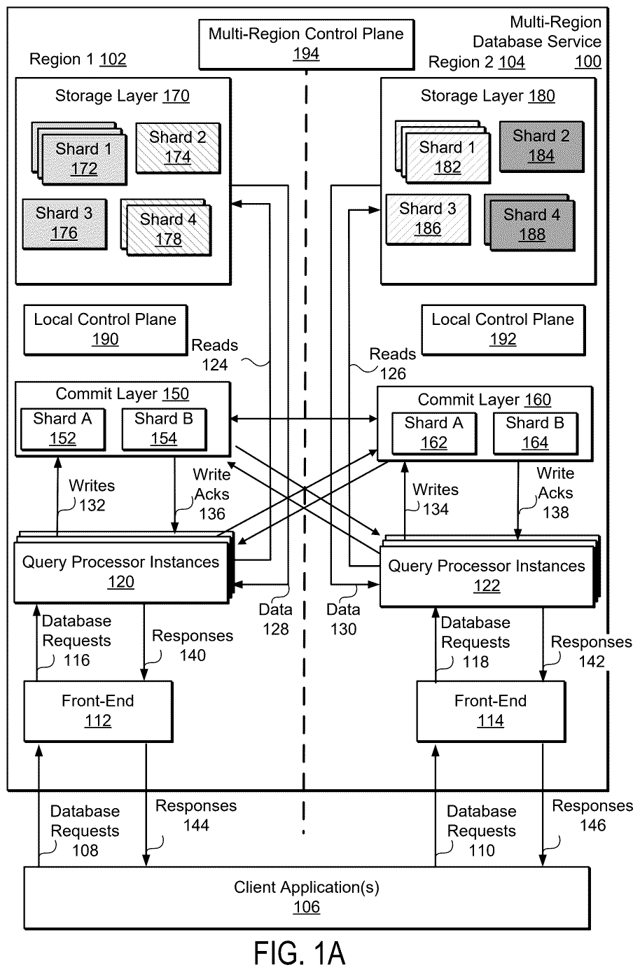

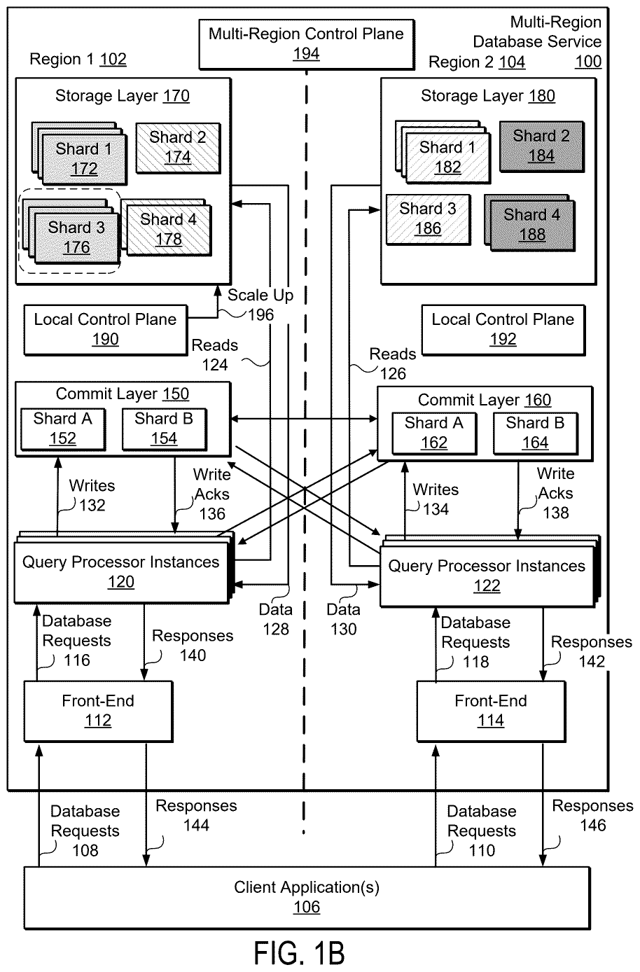

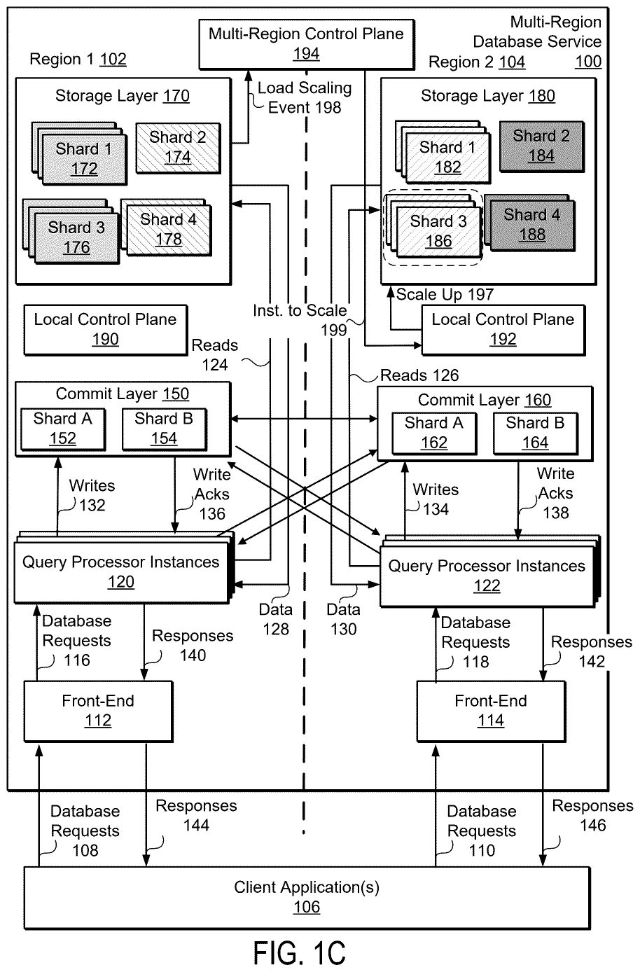

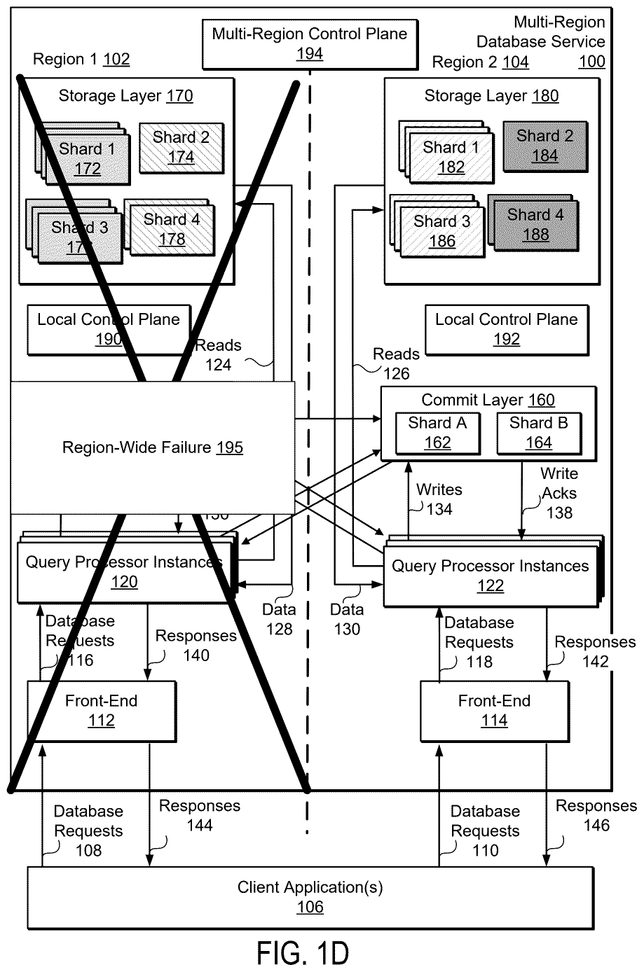

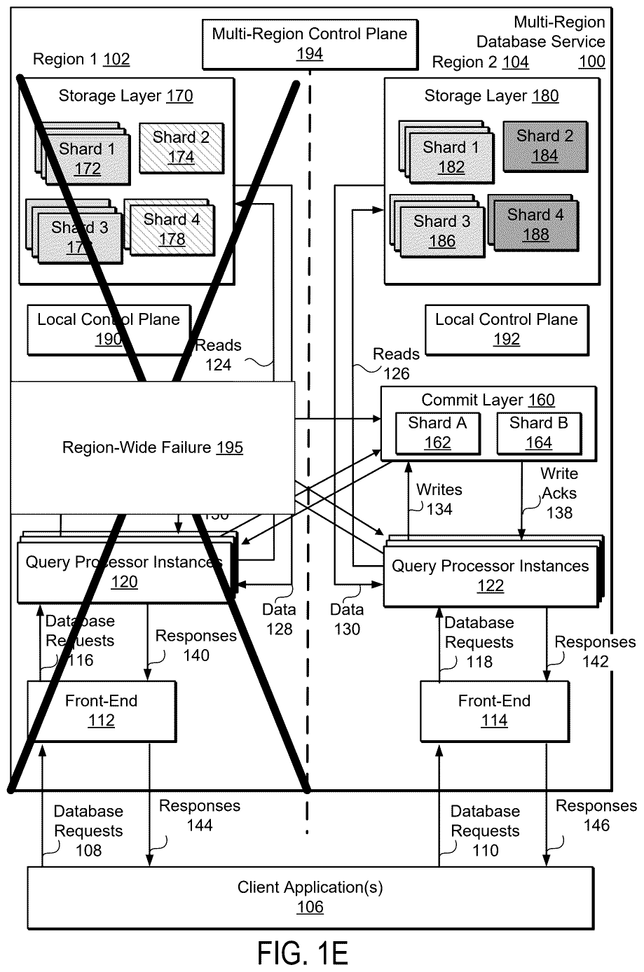

FIGS. 1A-1E are block diagrams illustrating a multi-region distributed database service which includes local control planes in each region and a multi-region control plane, wherein the multi-region control plane coordinates scaling across regions in order to have sufficient capacity to absorb the load of a given region, in remaining regions, in case of a region-wide failure event in the given region, according to some embodiments.

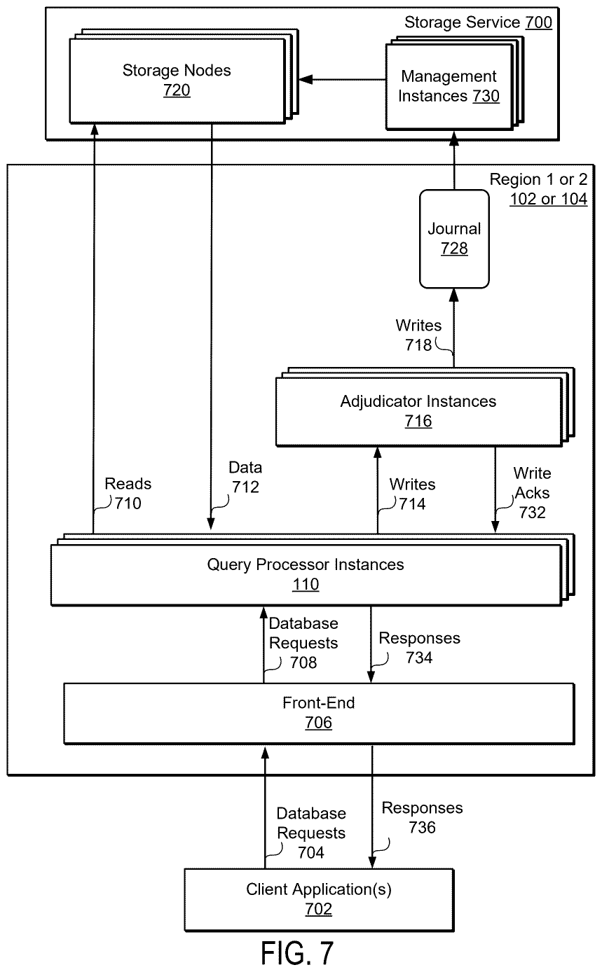

One or more client application(s) 106 may store data to one or more regional databases maintained by a multi-region database, such as one provided by multi-region database service 100. For example, clients may store data in region 1 (102) or region 2 (104) of the multi-region database service. Note that FIG. 7 illustrates components used to implement the commit layer 150/160 and the storage layer 170/180 of the respective regions, such as region 1 (102) or region 2 (104).

Client application(s) 106 may submit database requests 108 and 110 (e.g., requests that cause reads, such as queries or read-only transactions, or requests that cause writes, such as updates, inserts, deletions, or transactions that include write statements) and receive responses 146 from front-ends 112 and 114 in each of the respective regions 1 (102) and 2 (104).

Front-end 112 may dispatch database requests 116 to a query processor instance 120 in region 1 (102), which may parse the request and interact with different components of region 1 (102) according to the type of request. For read requests, query processor instance 120 may rely upon a local cache and/or access shards stored in storage nodes of storage layer 170 by submitting read requests 124 for data, which are returned as data 128 and used to respond to the read. For writes, write requests 132 may be sent to an adjudicator instance included in commit layer 150 and commit layer 160, which may determine whether a conflict exists and if not, writes are performed to a journal, such as journal 728 shown in FIG. 7, and acknowledgments of the write 136 are sent to query processor instance 120. In some embodiments, writes are committed to each region of the multi-region database, thus query processor instance 120 may submit writes and receive write acknowledgments from both commit layer 150 of region 1 (102) and commit layer 160 of region 2 (104). Responses 140 may then be sent to front-end 112 for response 144 to client application(s) 106. Transactions may be applied to the database by management instance in each of the regions that read committed writes from the journal and write the committed writes to shards included in a storage layer of each of the respective regions, such as storage layers 170 and 180. This may be performed at a time independent of the write acknowledgement 136, responses 140, and responses 144.

A similar process may be performed for region 2 (104), wherein database requests 110 are sent to front-end 114 and assigned to query processor instances 122. Query processor instances 122 may perform reads 126 to shards stored in storage layer 180 and receive, in response, data 130. Also, query processor instances 122 may issue writes 134 to commit layer 160 and receive write acknowledgements 138. The data read from the storage layer or the write acknowledgments received from the commit layer may be provided back to front-end 114 in responses 142. Also, the front-end 114 may forward information from responses 142 to client applications 106 as responses 146.

Each of regions 102 and 104 may implement a fleet of host computing devices which may provide, in various embodiments, a multi-tenant configuration so that different query processor instances, such as query processor instance 120 and 122 and other query processors, can be hosted on the same virtual machine, but provide access to different databases on behalf of different clients over different connections. In some embodiments, hosts systems may not be multi-tenant and a single virtual machine may implement a single query processor instance which may provide access to a single database for a single client. However, even in such embodiments, the underlying physical hardware may be multi-tenant, wherein virtual machines or containers for different clients are implemented using the same physical host computing device.

In some embodiments, database data for a database hosted in region 1 (102) or region 2 (104) may be stored in separate storage service regions. In some embodiments, a storage service may be used to store a regional copy of database data on virtual disk or other persistent storage drives.

In some embodiments, multiple shards may be used to manage the committing of writes in the respective commit layers 150 and 160 of the regions 1 (102) and 2 (104). For example, commit layer 150 shards the database keys into shards A (152) and B (154). Also, commit layer 160 shards the database keys into shards A (162) and B (164). Note that a write is performed in each region. Therefore, a query processor is assigned a given shard A or B of commit layer 150 to use to commit a write in region 1 (102) and additionally is assigned a given shard A or B of commit layer 160 to commit a write in region 2 (104).

Also, multiple shards may be used to manage the reading of committed data in respective storage layers of the regions. Note that the storage layer sharding may be different than the commit layer sharding for a same set of keys. For example, the commit layer only allows a key to be managed by a single shard in a given region. For example, in order to maintain consistency, only one adjudicator can be responsible for committing writes for unique keys to the journal in a given region. Other adjudicators may be responsible for other keys, but no more than one adjudicator is allowed to manage the same key. However, in the storage layer, more than one shard may store data for the same key. Thus, shards with overlapping key ranges and shard replicas may be stored in the storage layer. In some embodiments, the storage layer may be scaled to include more shards or shard replicas in order to satisfy a read load on the storage layer for a given set of keys.

Also, each region, such as region 1 (102) and region 2 (104) includes their own local control planes, such as local control plane 190 and 192. The local control plane for a given region is responsible for scaling the storage layer of that region. However, a multi-region control plane, such as multi-region control plane 194, may coordinate scaling activities performed by individual local control planes in the regions. For example, scaling may need to be coordinated across regions so that a less hot region of a multi-region database includes a sufficient number of storage layer shards to absorb the storage read load of a hotter region of the multi-region database, if there were to be a region-wide failure in the hotter region of the multi-region database.

For example, storage layer 170 of region 1 (102) includes three replicas (172) of shard 1 and a single replica (176) of shard 3 that are actively being used in region 1 to read data from these shards. Additionally, storage layer 180 includes three replicas (182) of shard 1 and a single replica (186) of shard 3. In the event of a region-wide failure in region 1 (102), the three shard 1 replicas 180 may take over the read load previously performed using the shard 1 replicas 172. Also, the single shard 186 of shard 3 may take over the read load previously handed by shard 3 (176).

In a similar manner, in the event of a region-wide failure in region 2, shard 2 (174) may take over the read load previously performed by shard 2 (184) and shard 4 and shard 4 replica 178 may take over the read load previously performed by shard 4 and shard 4 replica 188.

As more shards, or shard replicas, are added to storage layer 170 of region 1 (102) or storage layer 160 of region 2 (104), multi-region control plane 194 may coordinate with the respective local control planes 190 and 192 in each region to perform scaling actions proportional to load scaling events performed in other ones of the regions. For example, if additional shards or shard replicas are added to storage layer 170, such a load scaling event may be detected by multi-region control plane 194. In response, multi-region control plane 194 may provide shard heat information and/or local shard configuration information to remaining ones of the regions. For example, multi-region control plane 194 may provide shard heat information for the shards of storage layer 170 to the local control plane 192 for use in determining a scaling action to be performed for storage layer 180. In some embodiments, the current shard configuration of other storage layers in other regions may be provided to the local control planes. For example, multi-region control plane 194 may provide information about a shard configuration of storage layer 170 to the local control plane 192 for use in formulating a scaling action to be performed for storage layer 180 of region 2 (104).

For example, FIG. 1B shows local control plane 190 performing a scaling event 196 that causes shard 3 to be replicated to include two shard replicas of shard 3 (176). Also, as seen in FIG. 1C, load scaling event 198 (e.g. the adding of replicas for shard 3 (176)) is detected by multi-region control plane 194, which in turn issues an instruction to scale 199 to local control plane 192, which in turn performs a proportional scaling action 197 to add additional replicas to shard 3 (186). Note that in some embodiments, heat information may be provided to local control plane 192 in instruction to scale 199, and the local control plane 192 may formulate a scaling action to be taken based on its own scaling algorithm.

In the event of a region-wide failure event, such as region-wide failure 195 of region 1 (102) as shown in FIG. 1D, the load previously handled by the shards of storage layer 170 may be re-directed to the shards of storage layer 180. For example, as shown in FIG. 1E, shard 1 and its replicas (182) may transition to being actively used to perform read load that has been transitioned from region 1 (102) to region 2 (104). Also, shard 3 and its replicas (186) may be transitioned to being actively used to perform read load that has been transitioned from region 1 (102) to region 2 (104).

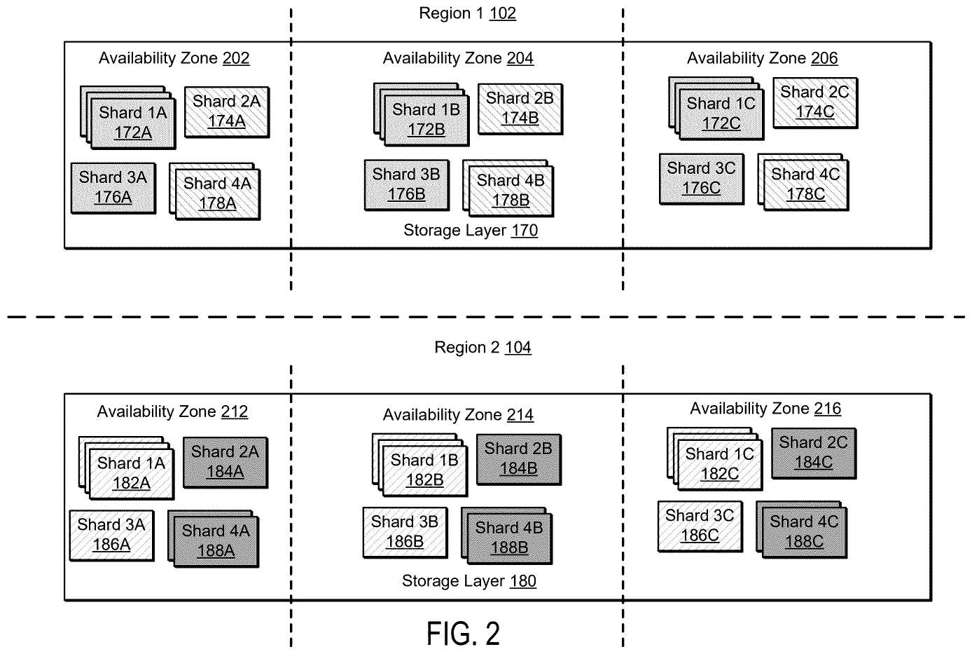

FIG. 2 is a block diagram illustrating availability zones of the respective regions, according to some embodiments.

In some embodiments, each of the regions, such as regions 1 (102) and 2 (104) include multiple availability zones, which each include an instance of a shard stored in the given region. For example, region 1 (102) may include availability zones 202, 204, and 206 each storing instances of shards 172, 174, 176 and 178. Likewise, region 2 (104) may include availability zones 212, 214, and 216 which each store instances of shards 182, 184, 186, and 188. In the event of a failure in a given availability zone, the remaining availability zones may service reads for that region until a replacement replica is in place in the availability zone experiencing the failure. A region-wide failure may result in all shard instances of a given region (such as availability zones 202, 204, and 206 for region 1; or availability zones 212, 214, and 216 for region 2) becoming unavailable. However, even in such a region-wide failure scenario, a multi-region distributed database, as described herein, may continue to service customer workloads by transitioning the workload to other regions. Moreover, a multi-region control plane, such as multi-region control plane 194, may ensure that each of the regions have already implemented sufficient storage layer capacity to absorb such workloads if transitioned to that given region from another region of the multi-region database.

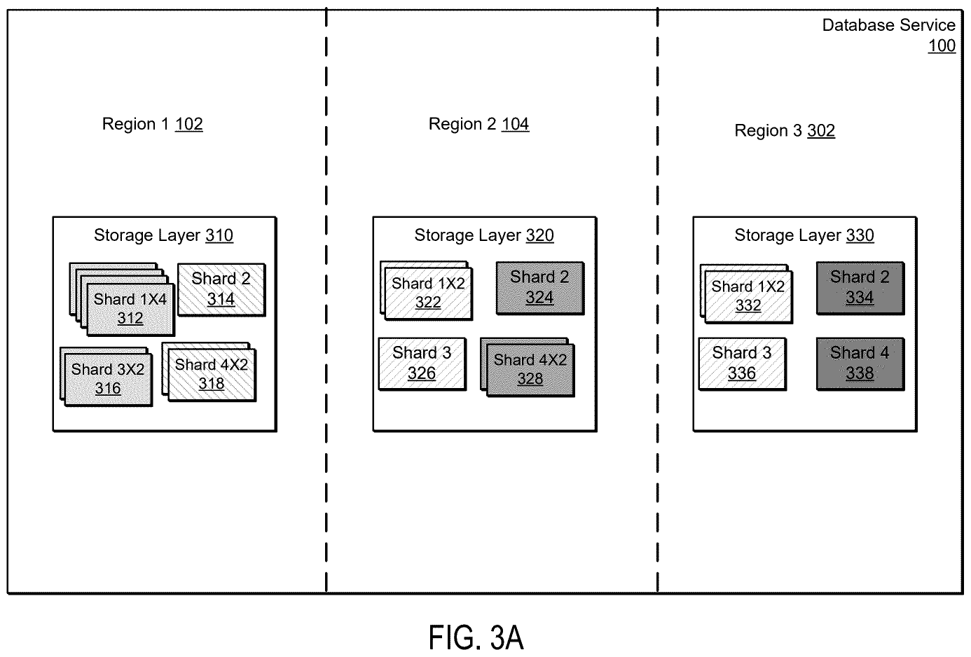

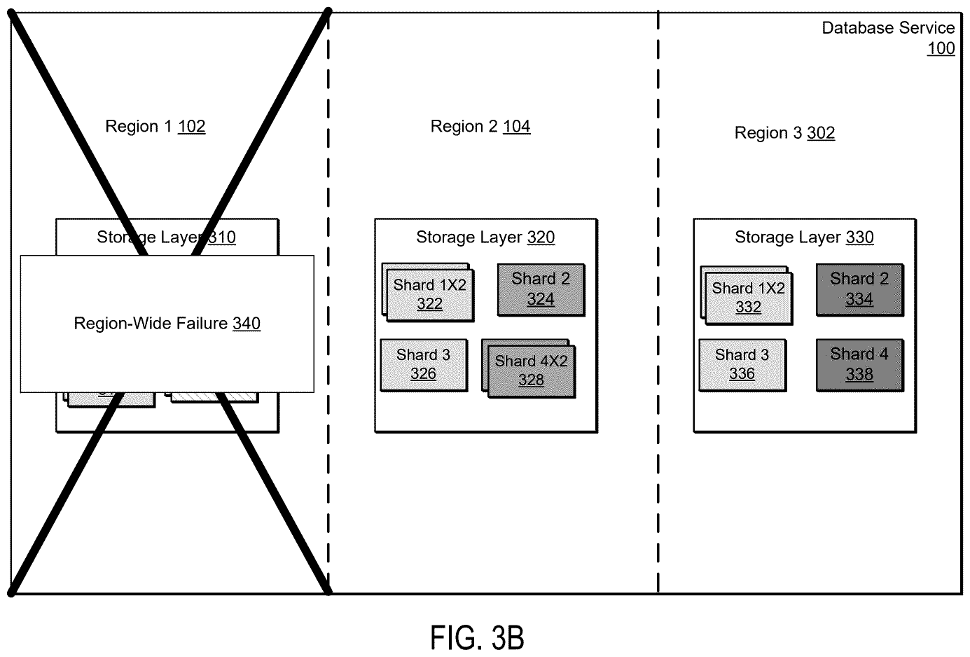

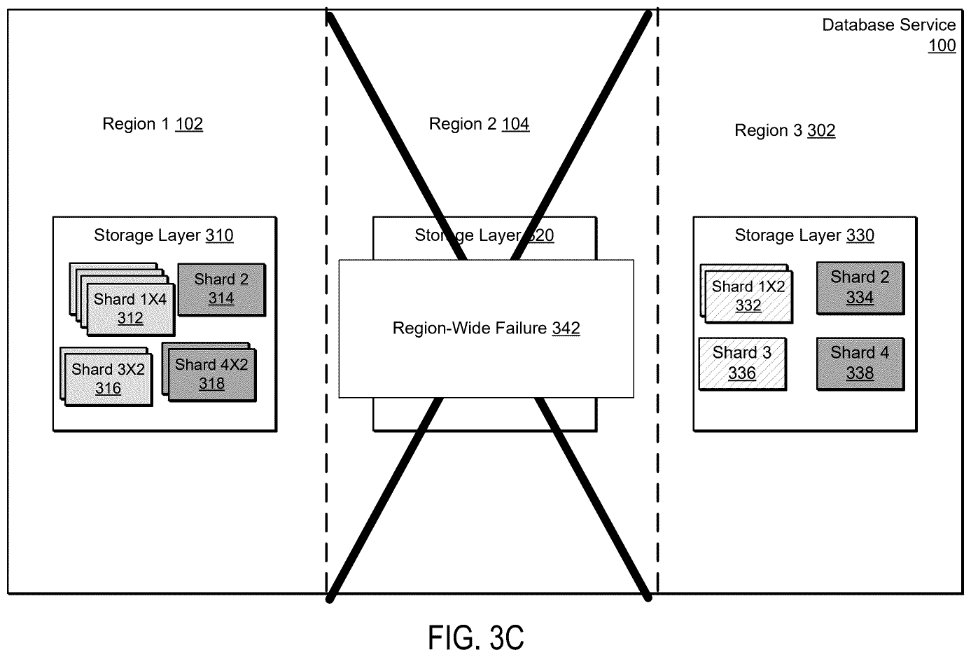

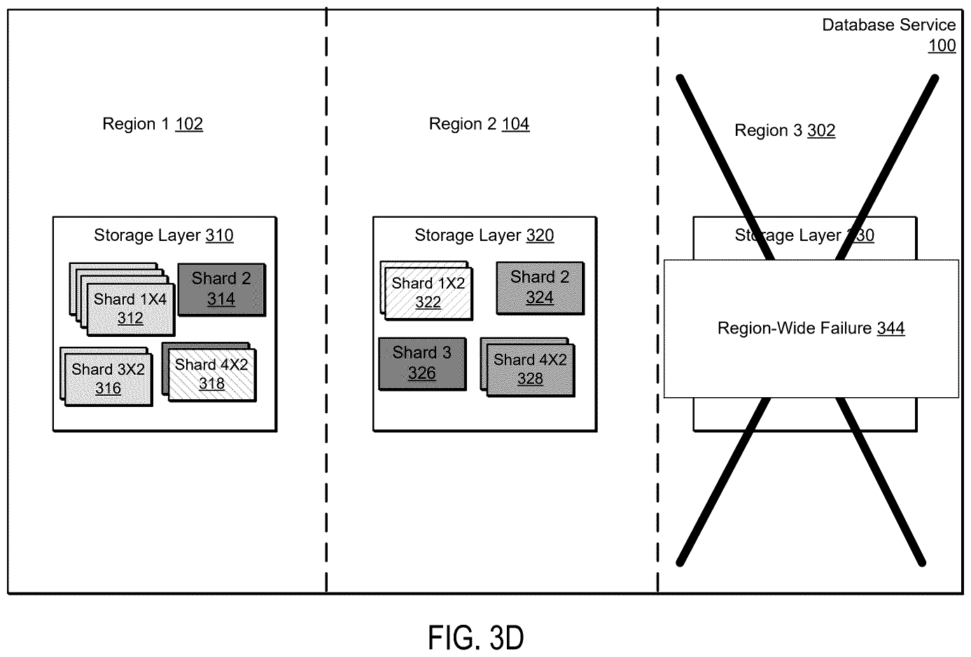

FIG. 3A is a block diagram illustrating a storage layer configuration for each region of a multi-region distributed database, wherein the multi-region distributed database includes more than two regions, according to some embodiments.

In the two-region example given above, each region may be required to implement capacity sufficient to service the workload of all regions (e.g. both its own workload and that of the other region). However, when more than two regions are used, it may be assumed that only one region experiences a region-wide failure at a time. Thus, the transitioned load from a failed region may be distributed among remaining regions in a three or more region multi-region database.

FIG. 3A illustrates example shard configurations for storage layers in a three or more region database. For example, storage layer 310 of region 1 (102) includes 4 shards 1 (312), a single shard 2 (314) that acts as spare capacity for other regions, and two shards 3 (316) and two shards 4 (318) that act as spare capacity for other regions. Also, storage layer 320 of region 2 (104) includes two shards 1 (322) that serve as spare capacity for other regions, a single shard 2 (324), a single shard 3 (326) which acts as spare capacity for other regions, and two shards 4 (328). Finally, storage layer 330 of region 3 (302) includes two shards 1 (332) that act as spare capacity for other regions, a single shard 2 (334), a single shard 3 (336) that acts as spare capacity for other regions, and a single shard 4 (338).

FIG. 3B is a block diagram illustrating a region-wide failure event occurring in a highest load region of a multi-region distributed database, wherein the load of the highest load region is shifted to remaining ones of the regions, according to some embodiments.

As can be seen in FIG. 3B in response to region-wide failure 340, shard 1 load (previously 4 replicas in region 1) is shifted to both of the sets of extra shard 1 capacity in regions 2 (104) and 3 (302). For example, shards 1 (322) of storage layer 320 and shards 1 (332) of storage layer 330 are now actively being used to handle read load transitioned away from region 1 (102). Similarly, shard 3 (326) of region 2 (104) and shard 3 (336) of region 3 (302) are used to handle load transitioned away from region 1 (102).

FIG. 3C is a block diagram illustrating a region-wide failure event occurring in an intermediate load region of a multi-region distributed database, wherein the load of the intermediate load region is shifted to another one of the regions, according to some embodiments.

As another example, due to region wide failure 342, shard 2 (314) of region 1 (102) handles load transitioned away from region 2 (104). Also, shards 4 (318) of region 1 (102) handle load transitioned away from region 2 (104).

FIG. 3D is a block diagram illustrating a region-wide failure vent occurring in a lowest load region of a multi-region distributed database, wherein the load of the lowest load region is shifted to remaining ones of the regions, according to some embodiments.

As yet another example, due to region-wide failure 344, shard 2 (314) of region 1 (102) handles load transitioned away from region 3 (302). Also, one of the two shards 4 (318) of region 1 (102) handles load transitioned away from region 3 (320).

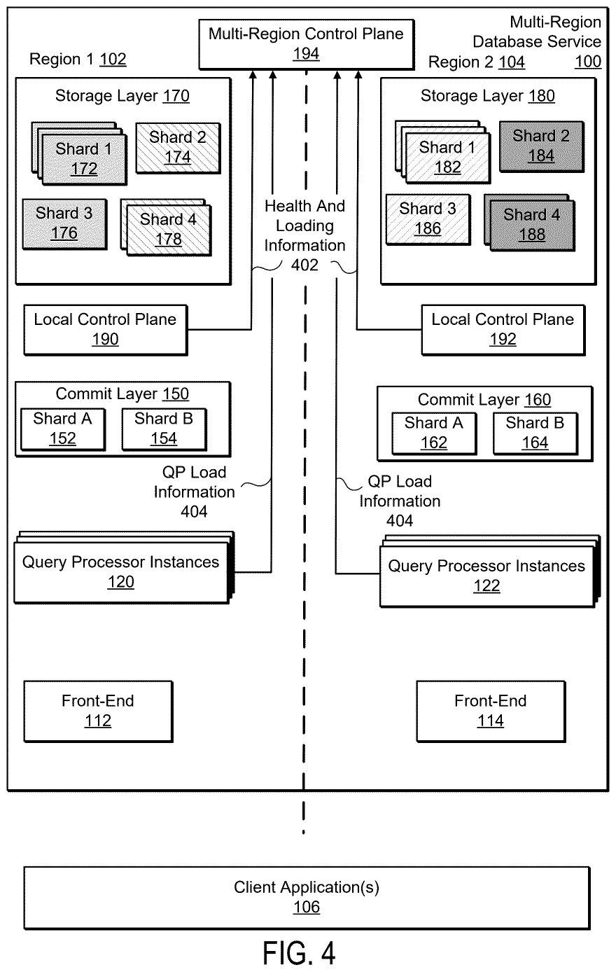

FIG. 4 is a block diagram illustrating a multi-region control plane a multi-region distributed database collecting health and loading information from components of the respective regions of the multi-region distributed database, according to some embodiments.

In some embodiments, multi-region control plane 194 may perform health monitoring to monitor the load of respective layers of the multi-region database. For example, multi-region control plane 194 collects health and loading information 402 from local control planes 190 and 192, as well as collecting query processor load information 404 from query processor instances 120 and 122.

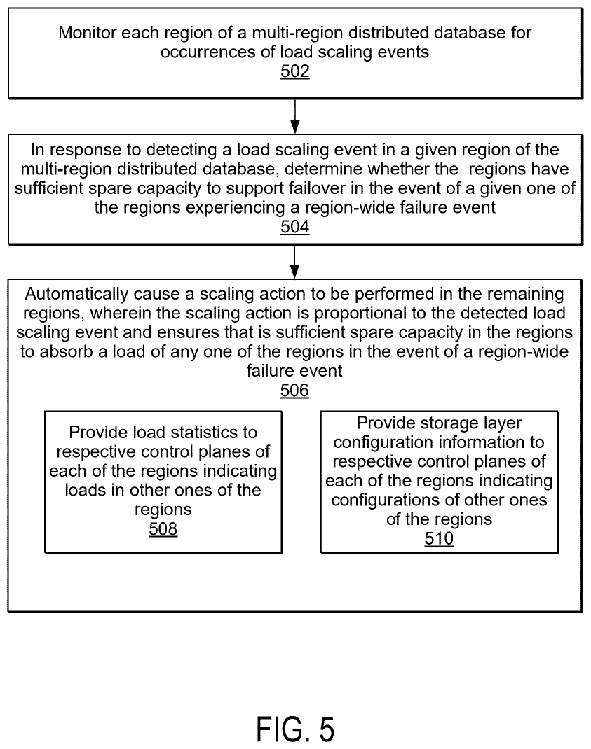

FIG. 5 is a flowchart for a process of monitoring and scaling storage layer capacity in each region of a multi-region distributed database in order to provide failover resilience, according to some embodiments.

At block 502, a multi-region control plane, such as multi-region control plane 194, monitors each region of a multi-region distributed database for occurrences of load scaling events.

At block 504, the multi-region control plane, in response to detecting a load scaling event in a given region of the multi-region distributed database, determines whether the regions have sufficient spare capacity to support failover in the event of a given one of the regions experiencing a region-wide failure event. Or alternatively provides information to the local control planes to locally determine an amount of capacity to be added to support failover in the event of a given one of the regions experiencing a region-wide failure event.

At block 506, the multi-region control plane automatically causes a scaling action to be performed in the remaining regions, wherein the scaling action is proportional to the detected load scaling event and ensures that is sufficient spare capacity in the regions to absorb a load of any one of the regions in the event of a region-wide failure event. In some embodiments, the scaling action is automatically performed by providing load statistics to respective control planes of each of the regions indicating loads in other ones of the regions, such as at block 508. In some embodiments, the scaling action is automatically performed by providing storage layer configuration information to respective control planes of each of the regions indicating configurations of other ones of the regions, at block 510.

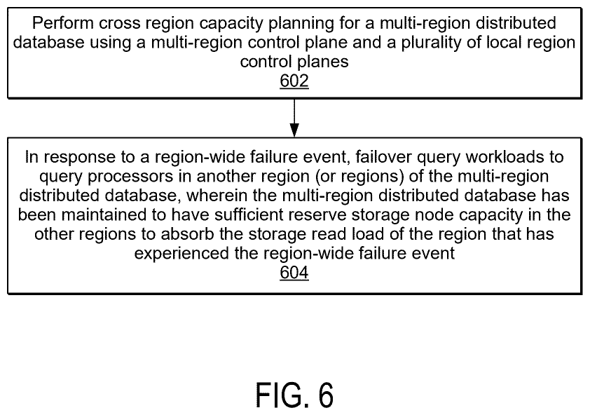

FIG. 6 is a flowchart for a process of performing a failover operation between regions of a multi-region distributed database, according to some embodiments.

At block 602, a multi-region control plane performs cross-region capacity planning for a multi-region distributed database using a multi-region control plane and a plurality of local region control planes.

At block 604, the multi-region control plane, in response to a region-wide failure event, fails over query workloads to query processors in another region (or regions) of the multi-region distributed database, wherein the multi-region distributed database has been maintained to have sufficient reserve storage node capacity in the other regions to absorb the storage read load of the region that has experienced the region-wide failure event.

FIG. 7 is a block diagram illustrating various components of a database service and storage service that host a distributed database, according to some embodiments.

One or more client application(s) 702 may store data to one or more databases maintained by a multi-region database, such as one provided by multi-region database service 100. For example, clients may store data in region 1 (102) or region 2 (104) of the multi-region database service. Note that FIG. 7 illustrates components used to implement the commit layer and storage layer of the respective regions, such as region 1 (102) or region 2 (104). Client application(s) 702 may submit database requests 704 (e.g., requests that cause reads, such as queries or read-only transactions, or requests that cause writes, such as updates, inserts, deletions, or transactions that include write statements) and receive responses 736 from front-end 706.

Front-end 706 may dispatch database requests 708 to a query processor instance 110, which may parse the request and interact with different components according to the type of request. For read requests, query processor instance 110 may rely upon a local cache and/or access storage nodes 720 by submitting read requests 710 for data, which are returned as data 712 and used to respond to the read. For writes, write requests 714 may be sent to an adjudicator instance 716, which may determine whether a conflict exists and if not, writes 718 to journal 728 and acknowledges the write 732 to query processor instance 110. Responses 734 may then be sent to front-end 706 for response 736 to client application(s) 702. Transactions may be applied to the database by management instance 730, at a time independent of the write acknowledgement 732, responses 734, and responses 736.

Each of regions 102 and 104 may implement a fleet of host computing devices which may provide, in various embodiments, a multi-tenant configuration so that different query processor instances, such as query processor instance 110 and other query processors, can be hosted on the same virtual machine, but provide access to different databases on behalf of different clients over different connections. In some embodiments, hosts systems may not be multi-tenant and a single virtual machine may implement a single query processor instance 110 which may provide access to a single database for a single client.

In some embodiments, database data for a database hosted in region 1 (102) or region 2 (104) may be stored in a separate storage service 700. In some embodiments, storage service 700 may be implemented to store a region copy of database data on virtual disk or other persistent storage drives. In some embodiments, embodiments, storage service 700 may store data for databases using tree structured storage and log structured storage.

For example, data may be organized in various logical volumes, segments, and pages for storage on one or more storage nodes 720 of storage service 700. For example, in some embodiments, each database may be represented by a logical volume, and each logical volume may be segmented into storage partitions over a collection of storage nodes 720. A storage partition (e.g. shard) may be an individual component that an individual query processor instance 110, for example, may communicate with. Each storage partition, which may be hosted on a particular one of the storage nodes, may contain a set of contiguous block addresses, in some embodiments.

In at least some embodiments, storage nodes 720 may provide multi-tenant storage so that data stored in a storage partition of one storage device may be stored for a different database, database user, account, or entity than data stored in another storage partition on the same storage device (or other storage devices) of the same storage node 720. Various access controls and security mechanisms may be implemented, in some embodiments, to ensure that data is not accessed at a storage node 720 except for authorized requests (e.g., for users authorized to access the database, owners of the database, etc.). For example, a cluster of database components may correspond to a particular database, and may use tokens specific to the cluster to identify and encrypt data.

In some embodiments, each storage partition may store a collection of one or more data pages and a change log (also referred to as a redo log) (e.g., a log of redo log records) for each data page that it stores. Storage nodes 720 may receive redo log records and coalesce them to create new versions of the corresponding data and/or additional or replacement log records (e.g., lazily and/or in response to a request for data or a database crash). In some embodiments, data and/or change logs may be mirrored across multiple storage nodes 720, according to a variable configuration (which may be specified by the client on whose behalf the database is being maintained in the database system). For example, in different embodiments, one, two, or three copies of the data or change logs may be stored in each of one, two, or three different availability zones or regions, according to a default configuration, an application-specific durability preference, or a client-specified durability preference.

In some embodiments, a volume may be a logical concept representing a highly durable unit of storage that a user/client/application of the storage system understands. A volume may be a distributed store that appears to the user/client/application as a single consistent ordered log of write operations to various user pages of a database, in some embodiments. Each write operation may be encoded in a log record (e.g., a redo log record), which may represent a logical, ordered mutation to the contents of a single user page within the volume, in some embodiments. Each log record may include a unique identifier (e.g., a Logical Sequence Number (LSN)), in some embodiments. Each log record may be persisted to one or more synchronous segments in the distributed store that form a Protection Group (PG), to provide high durability and availability for the log record, in some embodiments. A volume may provide an LSN-type read/write interface for a variable-size contiguous range of bytes, in some embodiments.

In some embodiments, journal 728, which may be a logical journal, may be hosted in a database service that stores ordered updates to the database (e.g., to a database volume). Adjudicator instances 716 may be responsible for deciding whether transactions or writes can be committed (while following isolation rules), for working with database journal 728 to order transactions, and for ensuring that committed data is consistent. Management instances 730, which may be a logical crossbar server, may apply updates to the database stored at the storage nodes 720 from the database journal 728 as directed by the adjudicator instances 716.

Front-end 706 may implement a proxy, request router, or other load balancing feature that routes database requests to one or more query processor instances 110. For example, front-end 706 may be responsible for authenticating requests to connect to a database at a particular network endpoint and allocating a query processor instance 110 to the connection (or to a particular request such as a read or a write). The front-end 706 may maintain the connection (e.g., as a proxy) so that if different query processor instances 110 are used for different requests to the database, separate connections do not have to be established.

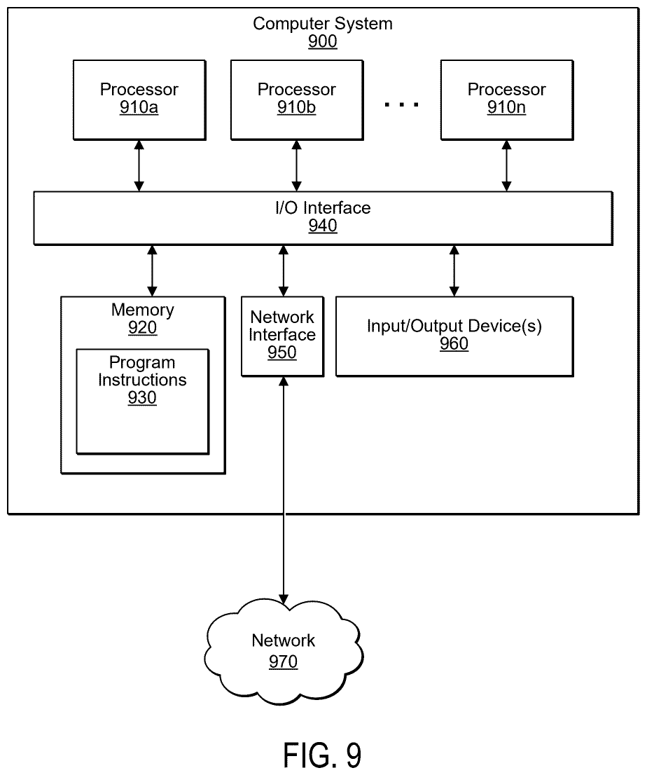

Each of the regions, such as region 1 (102) and region 2 (104), may implement a control plane which may manage the creation, provisioning, deletion, or other features of managing a database hosted in multi-region database service 100. For example, the control plane may monitor the performance of host computing devices (e.g., a computing system or device like computing system 900 discussed below with regard to FIG. 9) for high workloads (e.g., heat) and move or redirect placement of database engine head node instances away from some host computing devices to avoid overburdening host computing devices. The control plane may handle various management requests, such as requests to create databases or manage databases (e.g., by configuring or modifying performance), such as by enabling a “serverless” or other automated management feature in response to a request which may cause in-place resource scaling to be enabled for that database. The control plane may direct placement of database engine head node instances on host computing devices so as to distribute workload across host computing devices to avoid failure scenarios, like out-of-memory.

Each region, such as region 1 (102) and regio 2 (104), may implement one or more different types of database systems with respective query processor instances 110 for accessing database data as part of the database. For example, each region may implement various types of connection-based (e.g., having established a network connection between a database client and query processor instances 110 on a database host system) database systems which may, for instance, facilitate the performance of various operations that continue over multiple communications between the database client and the connected query processor instance 110. In at least some embodiments, multi-region database service 100 may be a relational database service that hosts relational databases on behalf of clients.

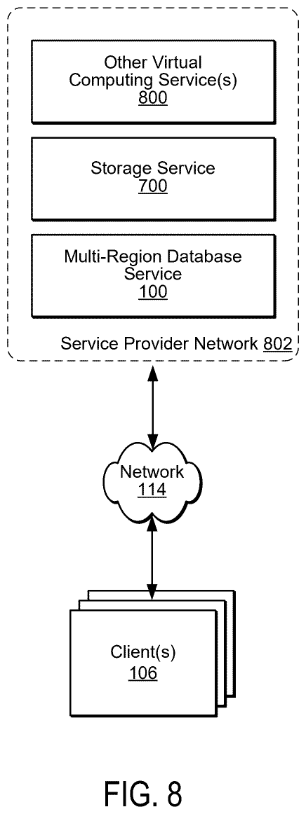

FIG. 8 is a block diagram illustrating a provider network that may implement database services that implement techniques described herein, according to some embodiments.

A service provider network 802 (sometimes referred to as a “cloud provider network” or “cloud”) refers to a pool of network-accessible computing resources (such as compute, storage, and networking resources, applications, and services), which may be virtualized or bare-metal. The service provider network 802 can provide convenient, on-demand network access to a shared pool of configurable computing resources that can be programmatically provisioned and released in response to user commands. These resources can be dynamically provisioned and reconfigured to adjust to variable load. Cloud computing can thus be considered as both the applications delivered as services over a publicly accessible network 114 (e.g., the Internet, a cellular communication network) and the hardware and software in cloud provider data centers that provide those services.

A service provider network 802 can be formed as a number of regions, where a region is a separate geographical area in which the cloud provider clusters data centers. Each region can include two or more availability zones connected to one another via a private high-speed network, for example, a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Users can connect to availability zones of the provider network via a publicly accessible network (e.g., the Internet, a cellular communication network) by way of a transit center (TC). TCs can be considered as the primary backbone locations linking users to the provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The provider network may deliver content from points of presence outside of, but networked with, these regions by way of edge locations and regional edge cache servers (points of presence, or PoPs). This compartmentalization and geographic distribution of computing hardware enables the provider network to provide low-latency resource access to users on a global scale with a high degree of fault tolerance and stability.

The provider network may implement various computing resources or services, which may include a virtual compute service, data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the provider network, which may be provisioned in user accounts.

The traffic and operations of the provider network may broadly be subdivided into two categories in various embodiments: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes customer resources that are implemented on the cloud provider network (e.g., computing instances, containers, block storage volumes, databases, file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

An exemplary provider network may include numerous provider network regions and so on that may include one or more data centers hosting various resource pools, such as collections of physical and/or virtualized computer servers, storage devices, networking equipment and the like (e.g., computing system 900 described below with regard to FIG. 9), needed to implement and distribute the infrastructure and storage services offered by the provider network within the provider network regions.

As illustrated in FIG. 8, a number of clients (shown as clients 106) may interact with a service provider network 802 via a network 114. Service provider network 802 may implement respective instantiations of the same (or different) services, such as a database service 100 for a first region and a second instantiation of database service 100 for a second region, and so on. Similar arrangements may be implemented for storage service 700, as well as various other virtual computing services 800. It is noted that where one or more instances of a given component may exist, reference to that component herein may be made in either the singular or the plural. However, usage of either form is not intended to preclude the other.

In various embodiments, the components illustrated in FIG. 8 may be implemented directly within computer hardware, as instructions directly or indirectly executable by computer hardware (e.g., a microprocessor or computer system), or using a combination of these techniques. For example, the components of FIG. 8 may be implemented by a system that includes a number of computing nodes (or simply, nodes), each of which may be similar to the computer system embodiment illustrated in FIG. 9 and described below. In various embodiments, the functionality of a given service system component (e.g., a component of the database service or a component of the storage service) may be implemented by a particular node or may be distributed across several nodes. In some embodiments, a given node may implement the functionality of more than one service system component (e.g., more than one database service system component).

Generally speaking, clients 106 may encompass any type of client configurable to submit network-based services requests to service provider network 802 via network 114, including requests for database services. For example, a given client 106 may include a suitable version of a web browser, or may include a plug-in module or other type of code module that may execute as an extension to or within an execution environment provided by a web browser. Alternatively, a client 106 (e.g., a database service client) may encompass an application such as a database application (or user interface thereof), a media application, an office application or any other application that may make use of persistent storage resources to store and/or access one or more database tables. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 106 may be an application which may interact directly with service of a region of a provider network. In some embodiments, client 106 may generate network-based services requests according to a Representational State Transfer (REST)-style web services architecture, a document-based or message-based network-based services architecture, or another suitable network-based services architecture. Although not illustrated, some clients of service provider network 802 services may be implemented within a service of the provider network (e.g., a client application of database service 100 may be implemented on one of other virtual computing service(s) 800), in some embodiments. Therefore, various examples of the interactions discussed with regard to clients 106 may be implemented for internal clients as well, in some embodiments.

In some embodiments, a client 106 (e.g., a database service client) may be provided access to network-based storage of database data to other applications in a manner that is transparent to those applications. For example, client 106 may be integrated with an operating system or file system to provide storage in accordance with a suitable variant of the storage models described herein. However, the operating system or file system may present a different storage interface to applications, such as a conventional file system hierarchy of files, directories, and/or folders. In such an embodiment, applications may not need to be modified to make use of the storage system service model, as described above. Instead, the details of interfacing to the provider network may be coordinated by client 106 and the operating system or file system on behalf of applications executing within the operating system environment.

Clients 106 may convey network-based services requests to and receive responses from a region of the provider network via network 114. In various embodiments, network 114 may encompass any suitable combination of networking hardware and protocols necessary to establish network-based communications between clients 106 and a service provider network 802. For example, network 114 may generally encompass the various telecommunications networks and service providers that collectively implement the Internet. Network 114 may also include private networks such as local area networks (LANs) or wide area networks (WANs) as well as public or private wireless networks. For example, both a given client 106 and the provider network region may be respectively provisioned within enterprises having their own internal networks. In such an embodiment, network 114 may include the hardware (e.g., modems, routers, switches, load balancers, proxy servers, etc.) and software (e.g., protocol stacks, accounting software, firewall/security software, etc.) necessary to establish a networking link between given client 106 and the Internet as well as between the Internet and a provider network. It is noted that in some embodiments, clients 106 may communicate with regions of a provider network using a private network rather than the public Internet. For example, clients 106 may be provisioned within the same enterprise as a database service. In such a case, clients 106 may communicate with a provider network region entirely through a private network 114 (e.g., a LAN or WAN that may use Internet-based communication protocols but which is not publicly accessible).

Generally speaking, service provider network 802 may implement one or more service endpoints which may receive and process network-based services requests, such as requests to access a database (e.g., queries, inserts, updates, etc.) and/or manage a database (e.g., create a database, configure a database, etc.). For example, a provider network region may include hardware and/or software which may implement a particular endpoint, such that an HTTP-based network-based services request directed to that endpoint is properly received and processed. In one embodiment, a provider network region may be implemented as a server system may receive network-based services requests from clients 106 and to forward them to components of a system that implements database service 100, storage service 700, and/or another virtual computing service 800 for processing. In other embodiments, provider network region may be configured as a number of distinct systems (e.g., in a cluster topology) implementing load balancing and other request management features may dynamically manage large-scale network-based services request processing loads. In various embodiments, a provider network region may support REST-style or document-based (e.g., SOAP-based) types of network-based services requests.

In addition to functioning as an addressable endpoint for clients'network-based services requests, in some embodiments, a service provider network 802 may implement various client management features. For example, service provider network 802 may coordinate the metering and accounting of client usage of network-based services, including storage resources, such as by tracking the identities of requesting clients 106, the number and/or frequency of client requests, the size of data tables (or records thereof) stored or retrieved on behalf of clients 106, overall storage bandwidth used by clients 106, class of storage requested by clients 106, or any other measurable client usage parameter. Provider network regions may also implement financial accounting and billing systems, or may maintain a database of usage data that may be queried and processed by external systems for reporting and billing of client usage activity. In certain embodiments, provider network regions may collect, monitor and/or aggregate a variety of storage service system operational metrics, such as metrics reflecting the rates and types of requests received from clients 106, bandwidth utilized by such requests, system processing latency for such requests, system component utilization, such as the target capacity determined for individual database engine head node instances, network bandwidth and/or storage utilization, rates and types of errors resulting from requests, characteristics of storage and databases (e.g., size, data type, etc.), or any other suitable metrics. In some embodiments, such metrics may be used by system administrators to tune and maintain system components, while in other embodiments such metrics (or relevant portions of such metrics) may be exposed to clients 106 to enable such clients to monitor their usage of database service 100, storage service 700 and/or another virtual computing service 800 (or the underlying systems that implement those services).

In some embodiments, provider network regions may also implement user authentication and access control procedures. For example, for a given network-based services request to access a particular database table, a provider network region may ascertain whether the client 106 associated with the request is authorized to access the particular database table. Provider network regions may determine such authorization by, for example, evaluating an identity, password or other credential against credentials associated with the particular database table, or evaluating the requested access to the particular database table against an access control list for the particular database table. For example, if a client 106 does not have sufficient credentials to access the particular database table, the provider network region may reject the corresponding network-based services request, for example by returning a response to the requesting client 106 indicating an error condition. Various access control policies may be stored as records or lists of access control information by database services 100, storage services 700, and/or other virtual computing services 800.

Note that in many of the examples described herein, services, like database service 100 or storage service 700 may be internal to a computing system or an enterprise system that provides database services to clients 106, and may not be exposed to external clients (e.g., users or client applications). In such embodiments, the internal “client” (e.g., database service 100) may access storage service 700 over a local or private network (e.g., through an API directly between the systems that implement these services). In such embodiments, the use of storage service 700 in storing database storage structures on behalf of clients 106 may be transparent to those clients. In other embodiments, storage service 700 may be exposed to clients 106 through service provider network 802 to provide storage of database tables or other information for applications other than those that rely on database service 100 for database management. In such embodiments, clients of the storage service 700 may access storage service 700 via network 114 (e.g., over the Internet). In some embodiments, a virtual computing service 800 may receive or use data from storage service 700 (e.g., through an API directly between the virtual computing service 800 and storage service 700) to store objects used in performing computing services 800 on behalf of a client 106. In some cases, the accounting and/or credentialing services of provider network region may be unnecessary for internal clients such as administrative clients or between service components within the same enterprise.

### Example Computer System

FIG. 9 is a block diagram illustrating an example computer system that implements some or all of the techniques described herein, according to some embodiments.

FIG. 9 illustrates exemplary computer system 900 usable to implement the processor allocator as described above with reference to FIGS. 1-8. In different embodiments, computer system 900 may be any of various types of devices, including, but not limited to, a network computer, a mobile device, a consumer device, application server, storage device, a peripheral device such as a switch, modem, router, or in general any type of computing or electronic device.

Various embodiments of program instructions for a processor allocator 930, as described herein, may be executed in one or more computer systems 900, which may interact with various other devices. Note that any component, action, or functionality described above with respect to FIGS. 1-8 may be implemented on one or more computers configured as computer system 900 of FIG. 9, according to various embodiments. In the illustrated embodiment, computer system 900 includes one or more processors 910 coupled to a system memory 920 via an input/output (I/O) interface 940. Computer system 900 further includes a network interface 950 coupled to I/O interface 940, and one or more input/output devices 960. In some cases, it is contemplated that embodiments may be implemented using a single instance of computer system 900, while in other embodiments multiple such computer systems, or multiple nodes making up computer system 900, may be configured to host different portions or instances program instructions as described above for various embodiments. For example, in one embodiment some elements of the program instructions may be implemented via one or more nodes of computer system 900 that are distinct from those nodes implementing other elements.

In some embodiments, computer system 900 may be implemented as a system on a chip (SoC). For example, in some embodiments, processors 910, memory 920, I/O interface 940 (e.g., a fabric), etc. may be implemented in a single SoC comprising multiple components integrated into a single chip. For example, a SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 920 may be configured to store compression or decompression program instructions for a processor allocator 930 accessible by one or more of the processors 910. In various embodiments, system memory 920 may be implemented using any suitable memory technology, such as static random-access memory (SRAM), synchronous dynamic RAM (SDRAM), nonvolatile/Flash-type memory, or any other type of memory. In the illustrated embodiment, program instructions for a processor allocator 930 may be configured to implement any of the functionality described above. In some embodiments, program instructions and/or data may be received, sent, or stored upon different types of computer-accessible media or on similar media separate from system memory 920 or computer system 900.

In one embodiment, I/O interface 940 may be configured to coordinate I/O traffic between processor 910, system memory 920, and any peripheral devices in the device, including network interface 950 or other peripheral interfaces, such as input/output devices 960. In some embodiments, I/O interface 940 may perform any necessary protocol, timing, or other data transformations to convert data signals from one component (e.g., system memory 920) into a format suitable for use by another component (e.g., processor 910). In some embodiments, I/O interface 940 may include support for devices attached through various types of peripheral buses, such as a variant of the Peripheral Component Interconnect (PCI) bus standard or the Universal Serial Bus (USB) standard, for example. In some embodiments, the function of I/O interface 940 may be split into two or more separate components, such as a north bridge and a south bridge, for example. Also, in some embodiments, some or all of the functionality of I/O interface 940, such as an interface to system memory 920, may be incorporated directly into processor 910.

Network interface 950 may be configured to allow data to be exchanged between computer system 900 and other devices attached to a network 970 (e.g., carrier or agent devices) or between nodes of computer system 900. Network 970 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 950 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 960 may, in some embodiments, include one or more display terminals, keyboards, keypads, touchpads, scanning devices, voice or optical recognition devices, or any other devices suitable for entering or accessing data by one or more computer systems 900. Multiple input/output devices 960 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 950.

As shown in FIG. 9, memory 920 may include program instructions for a processor allocator 930, which may be processor-executable to implement any element or action described above. In one embodiment, the program instructions may implement the methods described above. In other embodiments, different elements and data may be included.

Computer system 900 may also be connected to other devices that are not illustrated, or instead may operate as a stand-alone system. In addition, the functionality provided by the illustrated components may in some embodiments, be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A system, comprising:
a service provider network comprising a first region and one or more additional regions, wherein the first region and the one or more additional regions each respectively comprise:
a first set of computing devices configured to implement query processor instances for a multi-region distributed database;
a second set of computing devices configured to implement at least a portion of a commit layer for the multi-region distributed database; and
a third set of computing devices configured to implement a storage layer for the multi-region distributed database; and
one or more computing devices configured to implement a multi-region control plane for the multi-region distributed database, wherein the multi-region control plane is configured to:
monitor for read load scaling events in each of the storage layers of the region and the one or more additional regions; and
in response to detecting a read load scaling event being performed with regard to the storage layer of a given one of the regions, automatically cause the storage layers of the remaining ones of the regions to perform a scaling action proportional to the read load scaling event of the given region,
wherein a magnitude of the automatically performed scaling action is determined based on an amount of spare read capacity needed in the remaining ones of the regions to absorb a load of any one of the regions in response to a region-wide failure event.

2. The system of claim 1, wherein the first region and the one or more additional regions each respectively comprise:
a plurality of availability zones; and
respective groups of computing devices in each of the respective availability zones that implement the storage layer, wherein the third set of computing devices includes the groups of computing devices in each of the plurality of availability zones.

3. The system of claim 2, wherein the third set of computing devices implement storage nodes for the storage layer using virtualized computing instances that are configured to:
store a shard of data assigned to a given storage node; and
read data from the shard assigned to the given storage node in response to read requests from the query processor instances.

4. The system of claim 3, wherein the first region and the one or more additional regions each respectively comprise:
a local control plane configured to increase or decrease a number of replicas of a given shard that are maintained in the storage layer and/or re-shard data stored in the storage layer to increase a number of storage nodes that are storing shards of the data,
wherein the read load scaling event performed with regard to the storage layer of the given region comprises a local control plane of the given region adding more replicas or re-sharding data stored in the storage layer to increase a number of storage nodes used to store data in the storage layer of the given region, and
wherein the multi-region control plane causes the respective local control planes of the remaining ones of the regions to add more replicas or re-shared data stored in the storage layer such that the remaining ones of the regions have capacity to absorb the load of any one of the regions in response to a region-wide failure event.

5. The system of claim 4, wherein to automatically cause the storage layers of the remaining ones of the regions to perform a scaling action proportional to the read load scaling event of the given region, the multi-region control plane is configured to:
provide load statistics for each of the regions to each of the other ones of the regions.

6. The system of claim 4, wherein to automatically cause the storage layers of the remaining ones of the regions to perform a scaling action proportional to the read load scaling event of the given region, the multi-region control plane is configured to:
provide storage layer configuration information indicating a number of replicas used and a sharding scheme used for one or more other regions to each of the other ones of the regions.

7. A method, comprising:
monitoring each region of a plurality of regions of a multi-region database for an occurrence of a read load scaling event; and
in response to detecting a read load scaling event being performed with regard to a given one of the regions, automatically causing the remaining ones of the regions to perform a scaling action proportional to the read load scaling event of the given region,
wherein a magnitude of the automatically performed scaling action is determined based on an amount of spare read capacity needed in the remaining ones of the regions to absorb a load of any one of the regions in response to a region-wide failure event.

8. The method of claim 7,
wherein the read load scaling event changes a number of replicas or a number of shards implemented in a storage layer of the given region, and
wherein the scaling action causes a number of replicas or a number of shards implemented in respective storage layers of the remaining regions to be changed based on the change in the number replicas or shards in the given region.

9. The method of claim 7, wherein each of the regions comprise a plurality of availability zones, wherein:
the read load scaling event changes a number of replicas or a number of shards implemented in a storage layer in each of the availability zones of the given region; and
the scaling action causes a number of replicas or a number of shards implemented in respective storage layers of each of the availability zones of the remaining regions to be changed.

10. The method of claim 7, wherein the multi-region database comprises a first region and a second region, and wherein:
the first region comprises a number of replicas and a number of shards to service a load of the first region and a load that would be transferred to the first region in response to a region-wide failure of the second region; and
the second region comprises a number of replicas and a number of shards to service a load of the second region and a load that would be transferred to the second region in response to a region-wide failure of the first region.

11. The method of claim 7, wherein the multi-region database comprises a first region and a second region, and one or more additional regions,
wherein each of the regions comprises a number of replicas and a number of shards to service a load of the respective region and to service a fraction of a largest load of the remaining regions, and
wherein the fractions of capacity at each of the regions, other than the region with the largest load, collectively provide capacity for the largest load to be distributed among the remaining regions in response to a region-wide failure of the region with the largest load.

12. The method of claim 7, wherein the multi-region control plane is further configured to:
monitor query processor instance load in each of the regions of the multi-region database; and
provide an indication that query processing loads are to be increased in a given region in response to an amount of excess query processors capacity falling below a threshold amount, wherein the threshold amount accounts for query processing load that would be shifted to each of the regions in response to a region-wide failure event.

13. The method of claim 7, wherein automatically causing the storage layers of the remaining ones of the regions to perform a scaling action proportional to the scaling event of the given region comprises:
providing load statistics for each of the regions to each of the other ones of the regions.

14. The method of claim 7, wherein automatically causing the storage layers of the remaining ones of the regions to perform a scaling action proportional to the scaling event of the given region, comprises:
providing storage layer configuration information indicating a number of replicas used and a sharding scheme used for a highest capacity region to each of the other ones of the regions.

15. The method of claim 7, further comprising:
performing, by a local control plane of a given region of the multi-region distributed database, a read load scaling event based on a regional scaling algorithm; and
performing, by respective local control planes of other ones of the regions of the multi-region distributed database, respective local read load scaling events based on local regional scaling algorithms, wherein said performing the respective local read load scaling events are performed in response to a multi-region control plane of the multi-region distributed database providing load information for other ones of the regions to the respective local control planes.

16. One or more non-transitory, computer-readable storage media storing program instructions that, when executed on or across one or more processors, cause the one or more processors to:
monitor respective loads in storage layers of each region of a multi-region distributed database; and
in response to detecting a read load scaling event being performed with regard to a storage layer of a given one of the regions, automatically cause the storage layers of the remaining ones of the regions to perform a scaling action proportional to the read load scaling event of the given region.

17. The one or more non-transitory, computer-readable storage media of claim 16, wherein a magnitude of the automatically performed scaling action is determined based on an amount of spare read capacity needed in the remaining ones of the regions to absorb a load of any one of the regions in response to a region-wide failure event.

18. The one or more non-transitory, computer-readable storage media of claim 16, wherein the program instruction, when executed on or across the one or more processors, cause the one or more processors to:
implement local control planes in each of the regions of the multi-region distributed database, wherein:
the local control planes are configured to perform local scaling actions based on local load conditions and based on load information received from a multi-region control plane implemented via the program instructions.

19. The one or more non-transitory, computer-readable storage media of claim 18, wherein the load information provided by the multi-region control plane comprises:
load statistics for one or more other regions of the multi-region distributed database.

20. The one or more non-transitory, computer-readable storage media of claim 18, wherein the load information provided by the multi-region control plane comprises:
storage layer configuration information indicating a number of replicas used and a sharding scheme used for one or more other regions of the multi-region distributed database.
